(19) United States
(12) Patent Application Publication
(10) Pub. No.: US 2020/0147832 A1
(43) Pub. Date: May 14, 2020

(54) Mechanism bamboo charcoal processing apparatus

(71) Applicant: Di Zeng, Wuhan City (CN)

(72) Inventor: Di Zeng, Wuhan City (CN)

(21) Appl. No.: 16/732,351

(22) Filed: Jan. 2, 2020

(30) Foreign Application Priority Data
Oct. 31, 2019 (CN) 2019110524716

(51) Int. Cl. B28B 3/02

(52) U.S. Cl. CPC B28B 3/02

(57) ABSTRACT

The invention discloses a mechanism bamboo charcoal processing apparatus, which includes a machine body. A rotating rod is rotatably connected to the top surface of the machine body. The rotating rod is provided with an oil groove, and a sliding plate is slidably connected to the oil groove. The fixed block is rotatably connected. The carbonized bamboo block and bamboo joint are first put into the feeding port through the feeding port, and then the power motor is turned on. This device can grind the initially carbonized bamboo block and bamboo joint into a uniform particle. Compared with ordinary machines, the bamboo charcoal powder milled by this device is screened layer by layer to ensure that the particle size of the milled bamboo charcoal powder can be uniform, thereby ensuring the quality of the later-processed charcoal. The bamboo charcoal powder and the combustion promoter are mixed uniformly, and then pressed into uniform-sized machine-made charcoal.

### CROSS-REFERENCES TO RELATED APPLICATIONS

The present application claims priority from Chinese application No. 2019110524716 filed on Oct. 31, 2019 which is hereby incorporated by reference in its entirety.

### FIELD OF TECHNOLOGY

The invention relates to the field of bamboo processing, and in particular relates to a mechanism bamboo charcoal processing apparatus.

### TECHNICAL FIELD

Machine-made charcoal, as the name suggests, machine-made charcoal, also known as artificial charcoal, recycled charcoal, and smokeless clean charcoal, is a carbon rod made of wood scraps. It has a wide range of raw materials, including rice husks, peanut husks, and cotton husks. Corn cob, corn stalks, sorghum stalks, etc. can be used as raw materials for the production of charcoal. Sawdust, wood shavings, and bamboo shavings are the best. It has a high density and high calorific value, and is smokeless, odorless, non-polluting, non-explosive, easy to use. Burning is an internationally recognized green environmental protection product;

In the process of bamboo processing, there are often a large number of products such as bamboo sticks, bamboo branches, and bamboo chips. Some high-end machine-made charcoal are initially fired and then processed into machine-made charcoal. The subsequent bamboo joints need to be ground again and then processed again, but the process of grinding the bamboo joints into powder needs to be carried out thoroughly. Traditional processing machines have poor processing quality.

### CONTENT OF THE INVENTION

The purpose of the present invention is to provide a mechanism bamboo charcoal processing device to solve the problems raised in the background art mentioned above.

In order to achieve the above object, the present invention provides the following technical solution: A mechanism bamboo charcoal processing device includes a machine body, and a rotating rod is rotatably connected to the top surface of the machine body. A mobile sliding board is fixedly connected to the mobile sliding board. A fixed crushing barrel is fixed on the fixed block, and the crushing barrel is provided with a processing device for grinding bamboo sticks and bamboo chips into powder. The processing device includes a grinding cavity provided in the crushing barrel, a left side wall of the grinding cavity is provided with a feeding port, and a left side surface of the crushing barrel is fixedly provided with a feeding material connected to the feeding port. A reset cavity is provided on the lower side of the grinding cavity, and a linkage cavity is provided on the upper side of the feed port, and an extension shaft is rotatably connected to the front and rear side walls of the linkage cavity and the rear side of the crushing barrel. A rear pulley is fixed on the rear side of the extension shaft, a rear bevel gear is provided on the front side of the extension shaft, and the right side wall of the linkage chamber and the left side wall of the grinding chamber are rotatably connected Long axis, the left side of the long axis is fixed with the rear side bevel The meshing rotating bevel gear is provided with a grinding block fixed on the long shaft, a grinding head for grinding on the grinding block, and a long plate is slidably connected to the reset cavity. A connection spring is symmetrically connected between the left and right sides, and three long filters are fixedly connected to the top wall of the reset cavity and the bottom wall of the grinding cavity on the long plate, and the filter is slidably connected to the grinding head. The diameter of the filter decreases from left to right, and a switching device for pouring out the bamboo powder in the grinding cavity is also provided in the crushing barrel. A fuel tank is provided in the body, and the right side of the fuel tank is provided. The wall is provided with a hydraulic chamber, a hydraulic device for adjusting the angle of the hydraulic skateboard is provided in the hydraulic chamber, a social European driving chamber on the right side of the hydraulic chamber, and a driving device controlled by the hydraulic device is provided in the driving chamber. The power device is used to control the driving of the processing device. A driving cavity is provided on the bottom side of the driving cavity, a stirring cavity is provided on the top side of the driving cavity, and a molding cavity is provided on the right wall of the stirring cavity. The stirring cavity is provided for making bamboo powder into Molding apparatus charcoal shape.

On the basis of the above technical solution, the switch device includes a support shaft rotatably mounted on the front side of the support plate and the front and rear side walls of the grinding chamber, and the support shaft is fixed with a switching gear in the grinding chamber. The bottom wall of the grinding cavity is provided with an opening cavity, and a baffle which can block the grinding cavity is slidably connected in the opening cavity, and the baffle meshes with the switch gear.

Based on the above technical solution, the hydraulic device includes a hydraulic pump fixedly installed on the left side wall of the hydraulic chamber, a hose is connected to the top wall of the hydraulic chamber and the oil tank, and the hydraulic chamber is slidingly connected. There is a hydraulic slide, and the oil tank is provided with hydraulic oil.

Based on the above technical solution, the power device includes a hollow plate slidably mounted on the right wall of the hydraulic chamber and the left wall of the driving chamber, the hollow plate is fixedly connected to the hydraulic slide, and the hollow plate A motor block is fixed on the right side of the motor block, and a power motor is fixed in the motor block. A power shaft is connected to the power in the power motor. A driving gear is fixed on the bottom side of the power shaft. A gear shaft is rotatably connected to the wall, a passive gear meshing with the driving gear is fixed on the bottom side of the gear shaft, an active bevel gear is fixed on the upper side of the gear shaft, and the rear side wall of the driving cavity is rotatably connected. There is a rotating shaft, a driven bevel gear meshing with the driving bevel gear is fixed on the front side of the rotating shaft, and a connecting pulley is fixed on the rear side of the rotating shaft, and the connecting pulley is connected with the rear pulley A long belt is connected between them.

On the basis of the above technical solution, the molding device includes a linkage shaft rotatably installed on the bottom wall of the transmission cavity, and a rotation gear that can be engaged with the driving gear is fixed on the middle side of the linkage shaft. The linkage axis extends downward through the bottom wall of the driving cavity into the transmission cavity and is rotatably connected to the upper and lower side walls of the transmission cavity. A cam is provided on the bottom side of the linkage shaft, and the cam A ratchet mechanism is connected to the interlocking shaft. When the interlocking shaft is reversed, the cam can be driven to rotate by the ratchet mechanism. Forward rotation is not allowed. Sliding is connected to the transmission cavity. A return spring is connected between the push rod and the transmission cavity; a push slider is slidably connected to the right side of the push rod; a push spring is connected between the push slider and the push rod; The lifting chute is slidingly connected with three strong springs which can be connected with the pushing rod, the lifting plate can block the pushing slider, the lifting plate can block the molding cavity, and the stirring cavity The left wall and the right of the drive cavity A horizontal axis is rotatably connected between the walls, and a universal joint is rotatably connected on both sides of the horizontal axis. The universal joint on the left side is rotatably connected with the linkage shaft, and the universal joint on the right side is A vertical shaft is rotatably connected to the lower side, and a support plate fixedly connected to the left side wall of the stirring cavity is rotatably connected to the vertical shaft. A stirring block for stirring is fixed on the middle side of the vertical shaft. A screw block for feeding is fixed on the lower side of the screw. When the screw block rotates forward, the material is lifted upward, and when the spiral block is reversed, the material is transported downward, so that when the rotating gear rotates forward At this time, the linkage shaft, the universal joint, the horizontal axis, the vertical axis, the stirring block, and the spiral block are driven to rotate forward, so that the material is evenly mixed and the material is transported upward. Therefore, it is convenient for the stirring block to stir the bamboo charcoal powder uniformly.

On the basis of the above technical solution, a support for fixing is fixed on the bottom surface of the body.

On the basis of the above technical solution, a right side of the stirring cavity may be provided with a collecting bucket for receiving the carbon of the forming mechanism.

In summary, the beneficial effect of the present invention is that the device can grind preliminary carbonized bamboo blocks and bamboo sticks into bamboo charcoal powder with a uniform particle size. Compared with ordinary machines, the bamboo charcoal powder ground by the device passes through layers. Screening, to ensure that the particle size of the ground bamboo charcoal powder can be uniform, so as to ensure the quality of the later mechanism charcoal;

At the same time, the device can automatically mix the bamboo charcoal powder and the combustion promoter into a uniform, and then press into a uniform size of each mechanism carbon, so that the product specifications of the mechanism carbon can be guaranteed, and the manufactured mechanism carbon can be better ignited. Sex.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

FIG. 1 is a schematic front view of a mechanism of a bamboo charcoal processing device according to the present invention;

FIG. 2 is a partially enlarged view of A in FIG. 1 of the present invention;

FIG. 3 is a rear view of the crushing bucket in FIG. 1 according to the present invention.

### DETAILED DESCRIPTION OF THE INVENTION

All features disclosed in this specification, or all disclosed methods or steps, other than mutually exclusive features and/or steps, may be combined in any manner.

Any feature disclosed in this specification (including any additional claims, abstract, and drawings), unless specifically stated, may be replaced by other equivalent or similar purpose alternative features. That is, unless specifically stated, each feature is just one example of a series of equivalent or similar features.

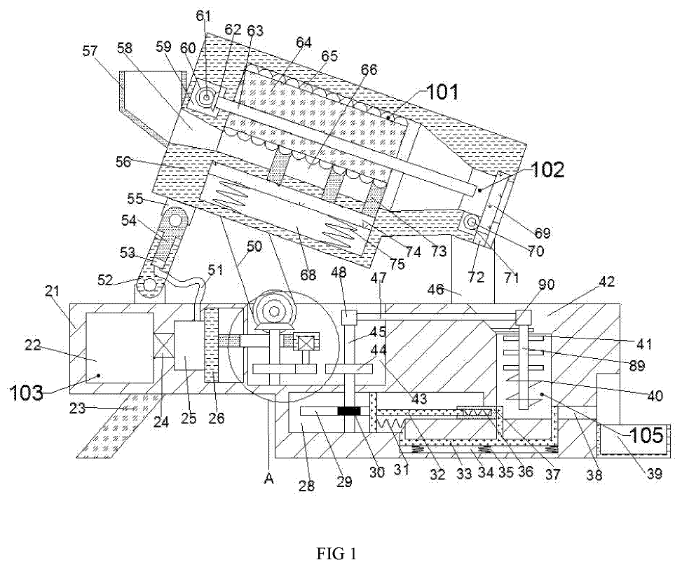

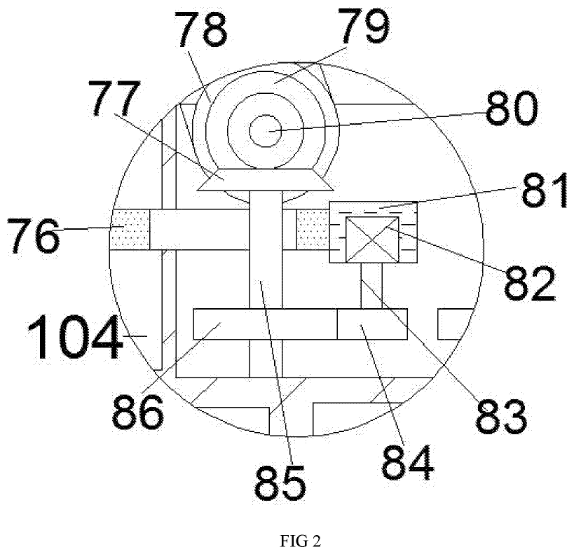

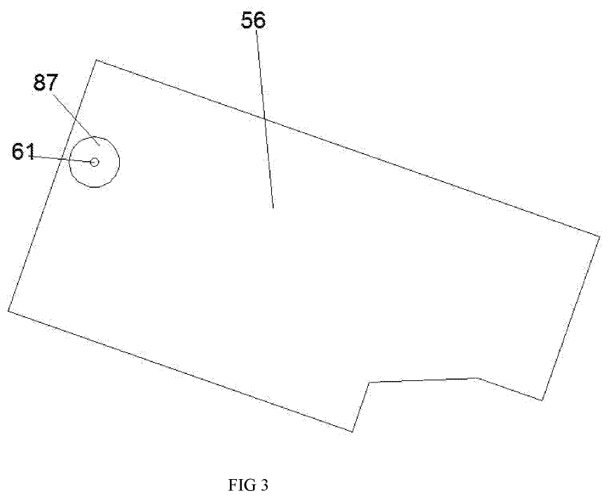

The present invention will be described in detail below with reference to FIGS. 1-3. Among them, for convenience of description, the orientation described below is defined as follows: the up-down, left-right, left-back, and up-down directions described below are consistent with the front-back, left-right, up, down, and down directions of the view direction of FIG. 1, 1 is a front view of the device of the present invention, and the direction shown in FIG. 1 is the same as the front, rear, left, right, and up and down directions of the device of the present invention.

Please refer to FIGS. 1-3. An embodiment of the present invention provides a mechanism for processing bamboo charcoal 101, which includes a body 21, and a rotating rod 52 is rotatably connected to the top surface of the body 21, and the rotating rod 52 is provided with An oil tank 53 is provided with a sliding plate 54 slidingly connected to the oil tank 53. A fixed block 55 is rotatably connected to the moving block 54. A fixed grinding block 56 is fixed on the fixed block 55. Processing device 101 for grinding bamboo sticks and bamboo chips into powder, the processing device 101 includes a grinding cavity 66 provided in the pulverizing bucket 56, and a feeding port 58 is provided on the left side wall of the grinding cavity 66 The left side of the crushing bucket 56 is fixedly provided with a feeding port 57 which is in communication with the feeding port 58. A lower side of the grinding chamber 66 is provided with a reset chamber 68. An interlocking cavity 59 is provided on the side, and an extension shaft 61 is rotatably connected to the front and rear side walls of the interlocking cavity 59 and the rear side of the pulverizing bucket 56. A rear pulley 87 is fixed on the rear side of the extension shaft 61. A rear bevel gear 60 is provided on the front side of the extension shaft 61, and the right side wall of the linkage cavity 59 and the left side wall of the grinding cavity 66 are connected in rotation. A long shaft 63 is connected to the left side of the long shaft 63. A rotating bevel gear 62 meshing with the rear bevel gear 60 is fixed. A grinding block 64 is fixed on the long shaft 63. A grinding head 65 is provided for grinding. A long plate 74 is slidably connected to the reset cavity 68. A connection spring 75 is connected symmetrically between the long plate 74 and the reset cavity 68. The long plate 74 is fixed on the top. There are three filter screens 73 slidingly connected to the top wall of the reset chamber 68 and the bottom wall of the grinding chamber 66. The filter screen 73 is slidingly connected to the grinding head 65. The filter screen 73 is from left to The right diameter decreases in sequence. A switch device 102 for pouring the bamboo powder in the grinding cavity 66 is also provided in the crushing bucket 56. An oil tank 22 is provided in the body 21, and a right wall of the oil tank 22 is provided. A hydraulic chamber 25 is provided, and a hydraulic device 103 for adjusting the angle of the hydraulic slide plate 26 is provided in the hydraulic chamber 25. A social drive chamber 43 on the right side of the hydraulic chamber 25 is provided with a hydraulic device. The power device 104 controlled by 103 is used to control the driving of the processing device 101, and the bottom side of the driving cavity 43 is provided with A driving cavity 28, a stirring cavity 42 is provided on the top side of the driving cavity 28, a molding cavity 38 is provided on the right side wall of the stirring cavity 42, and a stirring charcoal 42 is provided in the stirring cavity 42 for making the bamboo powder into a mechanism charcoal shape. [symbol] 105. The molding device 105.

In addition, in one embodiment, the switch device 102 includes a support shaft 70 rotatably mounted on the front side of the support plate 46 and the front and rear side walls of the grinding cavity 66. The support shaft 70 is located in the grinding cavity 66. A switch gear 71 is provided in the solid, and an opening cavity 72 is provided on the bottom wall of the grinding cavity 66, and a baffle 69 that can block the grinding cavity 66 is slidably connected to the opening cavity 72. The baffle 69 and The switch gear 71 is meshed, so that when the pulverizing bucket 56 rotates, the support shaft 70 and the switch gear 71 are driven to rotate, so that the baffle 69 can be pulled down to make the grinding The bamboo charcoal powder in the cavity 66 is dropped from the grinding cavity 66 into the stirring cavity 42.

In addition, in one embodiment, the hydraulic device 103 includes a hydraulic pump 24 fixedly installed on the left wall of the hydraulic chamber 25, and a hose 51 is connected to the top wall of the hydraulic chamber 25 and the oil tank 53, A hydraulic slide plate 26 is slidingly connected to the hydraulic chamber 25, and hydraulic oil is provided in the oil tank 22, so that the hydraulic pump 24 is opened, and the hydraulic oil in the oil tank 22 can be pumped into the hydraulic chamber 25. As a result, the hydraulic slide plate 26 is driven to move to the right, and at the same time, the hydraulic oil enters the oil groove 53 through the hose 51, thereby driving the moving slide plate 54 to move upward.

In addition, in one embodiment, the power unit 104 includes a hollow plate 76 slidingly mounted on the right wall of the hydraulic chamber 25 and the left wall of the driving chamber 43. The hollow plate 76 and the hydraulic slide plate 26 Fixedly connected, a motor block 81 is fixed on the right side of the hollow plate 76, and a power motor 82 is fixed in the motor block 81. A power shaft 83 is connected to the power motor 82. A driving gear 84 is fixed on the bottom side, and a gear shaft 85 is rotatably connected to the bottom wall of the driving cavity 43. A passive gear 86 meshing with the driving gear 84 is fixed on the bottom side of the gear shaft 85. A driving bevel gear 77 is fixed on the upper side of 85. A rotating shaft 80 is rotatably connected to the rear side wall of the driving cavity 43. A driven gear meshing with the driving bevel gear 77 is fixed on the front side of the rotating shaft 80. Bevel gear 79, a connecting pulley 78 is fixed on the rear side of the rotating shaft 80, and a long belt 50 is connected between the connecting pulley 78 and the rear pulley 87, so that when the driving gear 84 and the passive When the gear 86 is meshed, the power motor 82 is turned on, thereby driving the power shaft 83. The power shaft 83, the driving gear 84, the passive gear 86, the gear shaft 85, the driving bevel gear 77, the driven bevel gear 79, the rotating shaft 80, the connection The pulley 78 and the rear-side pulley 87 rotate.

In addition, in one embodiment, the molding device 105 includes a linkage shaft 45 rotatably mounted on the bottom wall of the transmission cavity 28, and a fixed side of the linkage shaft 45 is fixedly engaged with the driving gear 84. The rotating gear 44, the linkage shaft 45 extends downward through the bottom wall of the driving cavity 43 into the transmission cavity 28, and is rotatably connected to the upper and lower side walls of the transmission cavity 28, the linkage A cam 29 is provided on the bottom side of the shaft 45, and a ratchet mechanism 30 is connected between the cam 29 and the interlocking shaft 45. When the interlocking shaft 45 is reversed, it can be driven by the ratchet mechanism 30. The cam 29 rotates, but the forward rotation does not work. A sliding rod 32 is slidably connected to the driving cavity 28. A return spring 31 is connected between the driving rod 32 and the driving cavity 28. The right side of the driving rod 32 is A push slider 37 is slidably connected, and a push spring 36 is connected between the push slider 37 and the push rod 32. The lifting chute 34 is slidably connected to have three strong forces with the push rod 32. Spring 35, the lifting plate 33 can block the pushing slider 37, and the lifting plate 33 can block the A cavity 38 is blocked, and a horizontal axis 47 is rotationally connected between the left wall of the stirring cavity 42 and the right wall of the driving cavity 43, and a universal joint 48 is rotationally connected on both sides of the horizontal axis 47. The universal joint 48 on the left side is rotatably connected to the linkage shaft 45, and the lower side of the universal joint 48 on the right side is rotatably connected to a vertical shaft 89, and the vertical shaft 89 is rotatably connected to the vertical shaft 89. A support plate 90 is fixedly connected to the left side wall of the stirring cavity 42, a stirring block 41 for stirring is fixed on the middle side of the vertical shaft 89, and a spiral block 40 is fixed on the lower side of the vertical shaft 89. When the spiral block 40 rotates forward, the material is lifted upward, and when the spiral block 40 is reversed, the material is transported downward, so that when the rotating gear 44 is forwardly rotated, the linkage shaft 45 is driven. The universal joint 48, the horizontal axis 47, the vertical axis 89, the stirring block 41, and the spiral block 40 are rotated in the forward direction, so that the material is evenly mixed and the material is transported upward, thereby facilitating The stirring block 41 stirs the bamboo charcoal powder evenly. When the rotating gear 44 is reversed, the spiral block 40 is driven to reverse, so that the bamboo charcoal powder is downward. Lost, the interlocking shaft 45 is reversed, thereby driving the ratchet mechanism 30 and the cam 29 to rotate, thereby driving the push rod 32 to move to the right, so that the push spring 36 is compressed, and then when the push When the lever 32 moves to the far right, the lifting plate 33 is compressed downward, so that the pushing slider 37 is disengaged from the lifting plate 33. At this time, the molding cavity 38 is also opened, so The pushing slider 37 is pushed to the right by the pushing spring 36, so that the bamboo charcoal powder in the stirring cavity 42 is pushed into the molding cavity 38 to be molded, and then falls out of the molding cavity 38. When the cam When turning and resetting, the pushing rod 32 and the pushing slider 37 are moved to the left to reset, and the lifting plate 33 is reset by the strong spring 35.

In addition, in one embodiment, a support 23 is fixed on the bottom surface of the body 21.

In addition, in one embodiment, a right side of the stirring cavity 42 may be provided with a collecting barrel 39 for receiving the charcoal of the forming mechanism.

In the initial state, a preliminary carbonized bamboo block is added to the feeding port 58 through the feeding port 57. The baffle 69 closes the grinding cavity 66. The hydraulic slide plate 26 is located at the far left. The passive gear 86 meshes with the driving gear 84.

When it is necessary to grind the carbonized bamboo blocks and knots into powder, first put the carbonized bamboo blocks and knots into the feeding port 58 through the feeding port 57, and then turn on the power motor 82 to drive the power shaft 83, driving gear 84, passive gear 86, gear shaft 85, driving bevel gear 77, driven bevel gear 79, rotating shaft 80, connecting pulley 78, rear pulley 87, extension shaft 61, rear bevel gear 60, rotating cone The gear 62 and the long shaft 63 rotate, thereby driving the grinding block 64 and the grinding head 65 to rotate, so that the bamboo block is ground into a powder through the sliding connection between the grinding head 65 and the inner wall of the grinding cavity 66, and the powder is then filtered through the filter screen 73 to enter The rightmost side of the grinding cavity 66;

When the grinding is completed, the hydraulic pump 24 is turned on, so that the hydraulic oil in the oil tank 22 is sprayed into the hydraulic chamber 25, so that the hydraulic oil enters the oil groove 53 from the hose 51, thereby driving the moving slide plate 54 to slide to the right, thereby The grinding bucket 56 is driven to reverse, and the supporting shaft 70 and the switch gear 71 are rotated while the grinding bucket 56 is turned, thereby driving the baffle 69 to slide down, so that the grinding chamber 66 is opened, so that the fine bamboo charcoal powder in the grinding chamber 66 is ground. Falling from the grinding chamber 66 into the stirring chamber 42, when the hydraulic oil in the oil tank 22 enters the hydraulic chamber 25, the hydraulic slide plate 26 is driven to move to the right, so that the driving gear 84 meshes with the rotating gear 44, and then Pour the coagulant and combustion accelerator into the stirring chamber 42, and then turn on the power motor 82 in the forward direction to drive the rotation gear 44 to rotate forward through the driving gear 84, thereby driving the linkage shaft 45, the universal joint 48, the horizontal axis 47, and the vertical axis. The shaft 89, the stirring block 41, and the spiral block 40 rotate in the forward direction, so that the material is evenly mixed, and at the same time, the material is transported upwards, so that the stirring block 41 can evenly mix the bamboo charcoal powder, and then turn on the power motor 82 in the opposite direction, thereby driving The rotating gear 44 is reversed, so that the screw block 40 is reversed, so that the bamboo charcoal powder is transported downward, and the interlocking shaft 45 is reversed, so that the ratchet mechanism 30 and the cam 29 are rotated, and the push rod 32 is moved to the right, so that The push spring 36 is compressed, and then when the push rod 32 moves to the far right, the lift plate 33 is compressed downward, so that the push slider 37 is separated from the lift plate 33, and the molding cavity 38 is also opened at this time, pushing The slider 37 is pushed to the right by the pushing spring 36, so that the bamboo charcoal powder in the stirring cavity 42 is pushed into the molding cavity 38 and then dropped out of the molding cavity 38. When the cam 29 rotates and resets, the pushing rod 32 and the sliding slide The block 37 is reset by moving to the left, the lifting plate 33 is reset by the strong spring 35, and then the formed charcoal can be heated and dehydrated again.

The beneficial effect of the present invention is that the device can grind preliminary carbonized bamboo blocks and bamboo sticks into bamboo charcoal powder with uniform granularity. Compared with ordinary machines, the bamboo charcoal powder ground out by the device can be screened layer by layer to ensure that The particle size of the ground bamboo charcoal powder can be uniformed, thereby ensuring the quality of the later machine-made charcoal;

At the same time, the device can automatically mix the bamboo charcoal powder and the combustion promoter into a uniform, and then press into a uniform size of each mechanism carbon, so that the product specifications of the mechanism carbon can be guaranteed, and the manufactured mechanism carbon can be better ignited. Sex.

The above are only specific embodiments of the invention, but the scope of protection of the invention is not limited to this. Any changes or substitutions that are not thought through without creative work should be covered by the scope of protection of the invention. Therefore, the protection scope of the invention shall be subject to the protection scope defined by the claims.

1. A machine-made bamboo charcoal processing apparatus comprising a machine body, characterized in that: a top surface of the machine body is rotatably connected with a rotating rod, an oil groove is arranged in the rotating rod, and a sliding plate is slidably connected to the oil groove, and the movement A fixed block is rotatably connected to the slide plate, and a crushing barrel is fixed on the fixed block. The crushing barrel is provided with a processing device for grinding the bamboo and bamboo pieces and the like into powder. The processing device includes a The grinding cavity in the crushing barrel is provided with a feeding port on the left side wall of the grinding cavity, and the feeding surface communicating with the feeding port is fixed on the left side of the crushing barrel, and the grinding cavity A reset cavity is provided on the lower side of the feed opening, and a linkage cavity is provided on the upper side of the feed port. An extension shaft is rotatably connected to the front and rear side walls of the linkage cavity and the rear side of the crushing bucket. A rear side pulley is fixed on the rear side, a rear side bevel gear is provided on the front side of the extension shaft, and a long shaft is rotatably connected to the right wall of the linkage cavity and the left wall of the grinding cavity. A rotating bevel gear meshing with the rear bevel gear is fixed on the left side of the shaft, and the long shaft A grinding block is fixed on the grinding block, and a grinding head for grinding is arranged on the grinding block. A long plate is slidably connected in the reset cavity, and a connecting spring is symmetrically connected between the long plate and the reset cavity. Three filters are fixedly connected to the top wall of the reset cavity and the bottom wall of the grinding cavity. The filter is slidably connected to the grinding head. The diameter of the filter is from left to right. In turn, the crushing barrel is further provided with a switch device for pouring the bamboo powder in the grinding cavity. The body is provided with a fuel tank, and the right side wall of the fuel tank is provided with a hydraulic cavity. There is a hydraulic device for adjusting the angle of the hydraulic skateboard, a social European driving cavity on the right side of the hydraulic cavity, and a driving device controlled by the hydraulic device is provided in the driving cavity. The power device is used for controlling the processing device. Driving, a driving cavity is provided on the bottom side of the driving cavity, a stirring cavity is provided on the top side of the driving cavity, a molding cavity is provided on the right side wall of the stirring cavity, and a bamboo powder is provided in the stirring cavity. A molding device made into a machined carbon shape.

2. The mechanism bamboo charcoal processing device according to claim 1, wherein the switch device comprises a support shaft rotatably mounted on the front side of the support plate and the front and rear side walls of the grinding cavity, and the support shaft A switching gear is fixed in the grinding cavity, and an opening cavity is provided on the bottom wall of the grinding cavity. A baffle that can block the grinding cavity is slidably connected to the opening cavity. Switch gear meshes.

3. The mechanism bamboo charcoal processing device according to claim 1, wherein the hydraulic device comprises a hydraulic pump fixedly installed on the left wall of the hydraulic chamber, and the top wall of the hydraulic chamber and the oil groove A hose is connected to the hydraulic chamber, a hydraulic slide is slidingly connected to the hydraulic chamber, and hydraulic oil is provided in the oil tank.

4. The mechanism bamboo charcoal processing device according to claim 1, wherein the power device comprises a hollow plate slidingly installed on the right wall of the hydraulic cavity and the left wall of the driving cavity, and the hollow A plate is fixedly connected to the hydraulic skateboard. A motor block is fixed on the right side of the hollow plate, and a power motor is fixed in the motor block. A power shaft is connected to the power in the power motor. A driving gear is fixed on the side, a gear shaft is rotatably connected to the bottom wall of the driving cavity, a passive gear meshing with the driving gear is fixed on the bottom side of the gear shaft, and a driving gear is fixed on the upper side of the gear shaft. A bevel gear, a rotating shaft is rotatably connected to the rear side wall of the driving cavity, a driven bevel gear meshing with the driving bevel gear is fixed on the front side of the rotating shaft, and a rear side of the rotating shaft is fixed A connecting pulley, and a long belt is connected between the connecting pulley and the rear pulley.

5. The mechanism bamboo charcoal processing device according to claim 1, wherein the molding device comprises a linkage shaft rotatably mounted on the bottom wall of the transmission cavity, and a fixed side is fixed on the linkage shaft. A rotating gear that can be engaged with the driving gear, the linkage axis extends downward through the bottom wall of the driving cavity into the transmission cavity, and is rotatably connected to the upper and lower side walls of the transmission cavity. A cam is provided on the bottom side of the linkage shaft, and a ratchet mechanism is connected between the cam and the linkage shaft. When the linkage shaft is reversed, the cam can be driven to rotate by the ratchet mechanism. Turning does not work, a push rod is slidably connected to the transmission cavity, a return spring is connected between the push rod and the transmission cavity, and a push slider is slidably connected to the right side of the push rod, and the push slider A pushing spring is connected to the pushing rod, and three powerful springs are slidably connected to the pushing chute in the lifting chute. The lifting plate can block the pushing slider, and the lifting The plate can block the molding cavity, so A horizontal axis is rotatably connected between the left wall of the stirring cavity and the right wall of the driving cavity, and a universal joint is rotationally connected on both sides of the horizontal axis, and the universal joint on the left side is connected with the joint. A rotating shaft is rotationally connected, and a vertical shaft is rotationally connected to the lower side of the universal joint on the right side, and a support plate fixedly connected to the left side wall of the stirring chamber is rotationally connected to the vertical shaft. A stirring block for stirring is fixed on the side, and a spiral block for feeding is fixed on the lower side of the vertical shaft. When the spiral block is turned forward, the material is lifted upward, and when the spiral block is reversed, the screw block is fixed. The material is transported downward, so that when the rotating gear rotates forward, it drives the linkage shaft, the universal joint, the horizontal axis, the vertical axis, the stirring block, and the spiral block. The material is rotated to stir the material evenly, and at the same time, the material is transported upward, so that the stirring block can evenly stir the bamboo charcoal powder.

6. The machine-made bamboo charcoal processing device according to claim 1, characterized in that: a support for fixing is fixed on the bottom surface of the body.

7. The machine-made bamboo charcoal processing device according to claim 1, characterized in that: the right side of the stirring cavity can be provided with a collecting bucket for receiving the machine-made charcoal.
